(19) United States
(12) Patent Application Publication
(10) Pub. No.: US 2026/0278750 A1
(43) Pub. Date: Sep. 17, 2026

(54) FLOW-BASED IMAGE GENERATION MODEL WITH VELOCITY REFINER BLOCK

(71) Applicant: Bytedance Technology Ltd., Grand Cayman (KY)

(72) Inventors: Inkyu Shin, Los Angeles, CA (US); Chenglin Yang, Los Angeles, CA (US); Liang-Chieh Chen, Los Angeles, CA (US)

(21) Appl. No.: 19/566,743

(22) Filed: Mar. 13, 2026

Related U.S. Application Data
(60) Provisional application No. 63/771,587, filed on Mar. 13, 2025.

(51) Int. Cl. G06T 5/70; G06T 5/60; G06T 11/60

(52) U.S. Cl. CPC G06T 5/70; G06T 5/60; G06T 11/60; G06T 2207/20081

(57) ABSTRACT

A computing system including one or more processing devices configured to compute a generated image at a flow-based image generation model. Computing the generated image includes, in each denoising iteration, for each noised image patch, processing the noised image patch at a first transformer branch to compute a first latent velocity representation. At a velocity refiner block, computing the generated image further includes computing a latent acceleration representation based at least on the first latent velocity representation and computing a refined latent velocity representation based at least on the noised image patch and the latent acceleration representation. Computing the generated image further includes processing the refined latent velocity representation at a second transformer branch to compute a second latent velocity representation, and denoising the noised image patch based at least on the first and second latent velocity representations. The one or more processing devices output the generated image.

### CROSS REFERENCE TO RELATED APPLICATIONS

This application claims priority to U.S. Provisional Application No. 63/771,587, filed on Mar. 13, 2025, the disclosure of which is incorporated herein by reference in its entirety.

### BACKGROUND

Image generation machine learning (ML) models that utilize the strategy of “denoising from noise” have significantly propelled the advancement of visual generation. The processes of introducing and removing noise have given rise to two prominent families of generative models: diffusion-based models and flow-based models. Diffusion-based models utilize reverse the trajectory of a diffusion forward process by performing noise prediction. In contrast, flow-based models perform linear interpolation between noise and target signals, learning to predict the velocity of an interpolated noisy image under the principles of normalizing flows.

### SUMMARY

According to one aspect of the present disclosure, a computing system is provided, including one or more processing devices configured to compute a generated image at a flow-based image generation model. Computing the generated image includes, in each of a plurality of denoising iterations, for each of a plurality of noised image patches of a noised image, processing the noised image patch at a first transformer branch including a first plurality of transformer blocks to compute a first latent velocity representation. At a velocity refiner block, for each of the noised image patches, computing the generated image further includes receiving the noised image patch and the first latent velocity representation, computing a latent acceleration representation based at least in part on the first latent velocity representation, and computing a refined latent velocity representation based at least in part on the noised image patch and the latent acceleration representation. For each of the noised image patches, computing the generated image further includes processing the refined latent velocity representation at a second transformer branch including a second plurality of transformer blocks to compute a second latent velocity representation. For each of the noised image patches, computing the generated image further includes denoising the noised image patch based at least in part on the first latent velocity representation and the second latent velocity representation. The one or more processing devices are further configured to output the generated image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to execute a flow-based image generation model, according to one example embodiment.

FIG. 2A schematically shows an example of a velocity refiner block included in the flow-based image generation model, according to the example of FIG. 1.

FIG. 2B schematically shows another example of a velocity refiner block, according to the example of FIG. 1.

FIG. 3 schematically shows the computing system in an example in which the flow-based image generation model includes three or more transformer branches, according to the example of FIG. 1.

FIGS. 4A-4B schematically show the computing system during training of the flow-based image generation model, according to the example of FIG. 1.

FIG. 5A shows a flowchart of a method for use with a computing system to compute an image at a flow-based image generation model, according to the example of FIG. 1.

FIG. 5B shows additional steps of the method of FIG. 5A that may be performed in examples in which the flow-based image generation model includes a first velocity layer and a second velocity layer.

FIG. 5C shows additional steps of the method of FIG. 5A that may be performed at the velocity refiner block.

FIG. 5D shows additional steps of the method of FIG. 5A that may be performed to train the flow-based image generation model.

FIG. 6 shows a schematic view of an example computing environment in which the computer system of FIG. 1 may be instantiated.

### DETAILED DESCRIPTION

Despite recent advancements in flow-based image generation, existing flow-based models do not enhance their internal velocity representations with additional data. Such existing flow-based models typically rely on sequentially stacked multi-layered transformer blocks to compute the velocity exclusively from the final layer. This approach under-utilizes the significance of intermediate velocity representations, leading to challenges such as slow training convergence and low performance. Other existing flow-based generative models compute intermediate velocity representations as external features using pre-trained self-supervised models. Using these external features may result in higher image generation quality and shorter training times. However, this reliance on external self-supervised models overlooks the opportunity to internally rectify feature misalignment between transformer layers.

The present disclosure provides a flow-based image generation model that incorporates deep supervision into a sequence of transformer layers by computing respective velocity estimates using the velocity representations output by different transformer branches. This deep supervision increases the alignment of the internal velocity representations with output velocity representations. Aligning the intermediate and output velocity representations using the techniques discussed below also increases image generation quality, as indicated by decreases in Fréchet inception distance (FID) compared to baseline flow-based image models.

In addition to aligning the intermediate and output velocity representations, the flow-based image generation model discussed below also integrates deep supervision into the computation of the intermediate velocity representations. This deep supervision is performed using a lightweight block located between adjacent branches of transformer blocks. This block, referred to below as the velocity refiner block, is trained to model acceleration and to map the velocity features of the previous branch onto those of the subsequent branch. The velocity refiner block modifies velocity features by conditioning on adjacent branches across different timesteps in a manner that is guided by principles of second-order dynamics.

To implement the velocity refiner block, a multi-layer perceptron (MLP) is trained to receive a previous velocity feature and to generate an acceleration feature using a second-order ordinary differential equation (ODE). The previous velocity feature is subsequently concatenated with the acceleration feature. Time-gap-conditioned adaptive layer normalization is then applied to the concatenated feature, resulting in velocity features aligned with those of the subsequent branch. The layer-normalized velocity features are further refined by incorporating spatial information through cross-space attention, thereby facilitating interaction between the refined velocity and spatial feature spaces. The refined latent velocity representation computed at the velocity refiner block is significantly closer to the output velocity feature of the transformer branches, compared to intermediate velocity features computed without using the velocity refiner block. This deep supervision accordingly increases the quality of the generated images compared to baselines.

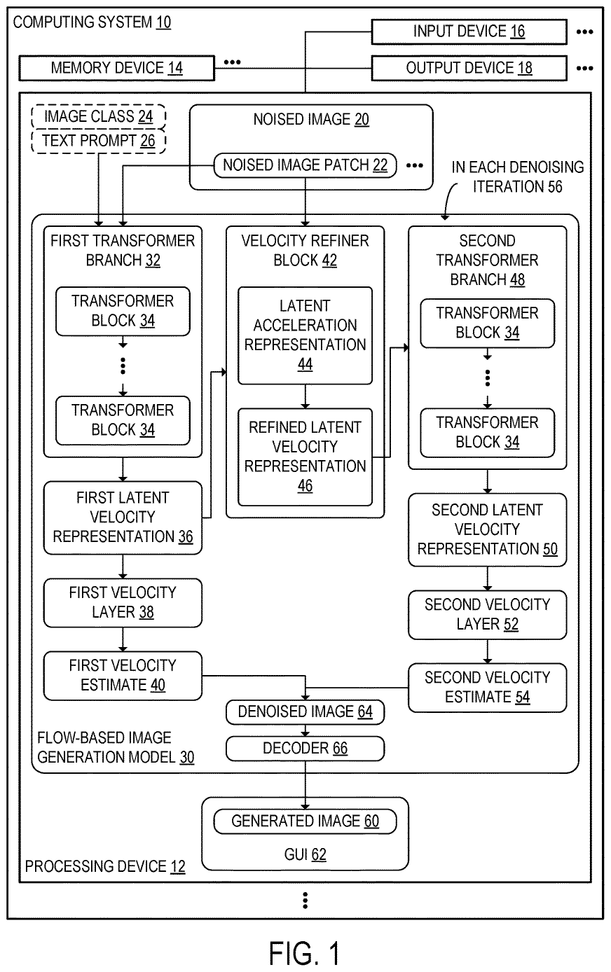

FIG. 1 schematically shows a computing system 10 at which one or more processing devices 12 are configured to execute a flow-based image generation model 30 to compute a generated image 60, according to one example embodiment. For example, the one or more processing devices 12 may include one or more central processing units (CPUs), graphics processing units (GPUs), and/or neural processing units (NPUs). The computing system 10 further includes one or more memory devices 14, which may include volatile memory and/or non-volatile storage. In addition, the computing system 10 further includes one or more input devices 16 and one or more output devices 18 via which a user may interact with the computing system 10. The one or more input devices and the one or more output devices 18 may be used to present a graphical user interface (GUI) at which the user may enter the inputs of text-to-image (T2I) generation and view the generated image 60.

In some examples, the computing system 10 is instantiated across a plurality of physical computing devices. For example, the computing system 10 may have a server-client configuration in which the inputs and outputs of the flow-based image generation model 30 are client-facing and the flow-based image generation model 30 is executed at a server computing device. In the server-client configuration, the generated image 60 may also be distributed for display at a plurality of different client devices.

FIG. 1 shows the flow-based image generation model 30 at inferencing time. As shown in FIG. 1, the one or more processing devices 12 are configured to compute the generated image 60 over a plurality of denoising iterations 56, starting from a noised image 20. In some examples, the flow-based image generation model 30 is configured to perform class-conditional image generation and is further configured to receive an image class 24 as an input. Alternatively, the flow-based image generation model 30 may be configured to perform prompt-conditional image generation and is further configured to receive a text prompt 26 as an input.

In the example of FIG. 1, the noised image 20 is divided into a plurality of noised image patches 22. For example, each of the noised image patches 22 may be an image token in the latent space of an image encoder, as discussed in further detail below. The one or more processing devices 12 are configured to denoise each of the noised image patches 22 in each of the denoising iterations 56.

An existing approach to flow-based generative modeling is discussed below. In this existing approach, normalizing flows form a time-dependent velocity field v:[0,1]× [symbol] ^{d}→ [symbol] ^{d} This time-dependent velocity field v is used to compute a flow map φ:[0,1]× [symbol] ^{d}, which is used to map noise z to a target distribution x₀. The time-dependent velocity field is modeled using a neural network v_{θ}(xₜ) that predicts the velocity of a tokenized image xₜ at time-step t and has parameters θ. Thus, the neural network may generate target samples from Gaussian noise by performing a plurality of denoising iterations using predicted velocity outputs. During training of the neural network, a forward noising step may be performed via linear interpolation between prior noise (x₁~ [symbol] (0,1) and a target distribution (x₀), as shown in the following equation:

$${x}_{t} = t \cdot {x}_{1} + ( 1 - t ) \cdot {x}_{0} \qquad ( 1 )$$

where t∈[0,1] denotes the timestep of the interpolation coefficient.

The neural network is trained to output velocity predictions that match a ground-truth velocity V=x₁−x₀. This training is performed using the following objective function:

$$ℒ ( θ ) = 𝔼 {‖ {v}_{θ} ( {x}_{t} ) - V ‖}^{2} \qquad ( 2 )$$

The neural network may have a diffusion transformer architecture. This architecture includes a plurality of transformer blocks that apply self-attention to input tokens, followed by AdaLN-Zero modulation conditioned on the timestep. In addition, the AdaLN-Zero modulation is conditioned on an image class or text prompt. The objective function may accordingly be expressed as follows:

$$ℒ ( θ ) = 𝔼 {‖ {v}_{θ} ( {x}_{t} , t , c ) - V ‖}^{2} \qquad ( 3 )$$

where t and c are the input timestep and the image class, respectively.

The following discussion relates to the architecture of the flow-based image generation model 30 of FIG. 1, including the differences between the flow-based image generation model 30 and the neural networks used in existing approaches to flow-based image generation. The flow-based image generation model 30 includes a plurality of transformer branches that each include a plurality of transformer blocks 34. The transformer blocks 34 are arranged in series within each transformer branch. For each of the noised image patches 22, the one or more processing devices 12 are configured to process that noised image patch 22 at a first transformer branch 32 including a first plurality of transformer blocks 34 to compute a first latent velocity representation 36.

At a first velocity layer 38 included in the flow-based image generation model 30, the one or more processing devices 12 are further configured to compute a first velocity estimate 40 based at least in part on the first latent velocity representation 36. The first velocity estimate 40 is associated with a first timestep t₁.

The flow-based image generation model 30 further includes a velocity refiner block 42, which is located between the first transformer branch 32 and a second transformer branch 48. At the velocity refiner block 42, the one or more processing devices 12 are further configured to receive the noised image patch 22 and the first latent velocity representation 36. The one or more processing devices 12 are further configured to compute a latent acceleration representation 44 at the velocity refiner block 42 based at least in part on the first latent velocity representation 36. In addition, at the velocity refiner block 42, the one or more processing devices 12 are further configured to compute a refined latent velocity representation 46 based at least in part on the noised image patch 22 and the latent acceleration representation 44. Thus, the velocity refiner block 42 modifies the first latent velocity representation 36 by incorporating an acceleration estimate.

The one or more processing devices 12 are further configured to process the refined latent velocity representation 46 at a second transformer branch 48 including a second plurality of transformer blocks 34. Accordingly, the one or more processing devices 12 are configured to compute a second latent velocity representation 50. In addition, at a second velocity layer 52, the one or more processing devices 12 are further configured to compute a second velocity estimate 54 based at least in part on the second latent velocity representation 50. The second velocity estimate 54 is associated with a second timestep t₂.

In each of the denoising iterations 56, the one or more processing devices 12 are further configured to denoise the noised image patch 22 based at least in part on the first latent velocity representation 36 and the second latent velocity representation 50. The noised image patch 22 is denoised based at least in part on the first velocity estimate 40 and the second velocity estimate 54 computed for that denoising iteration 56 in the example of FIG. 1. By denoising each of the noised image patches 22 included in the noised image 20, the one or more processing devices 12 are configured to compute the generated image 60 over the plurality of denoising iterations 56. By denoising the noised image patches 22, the one or more processing devices 12 are configured to compute a denoised image 64. The one or more processing devices 12 may be further configured to pass the denoised image 64 through a decoder 66, which may be an ML model trained to convert the denoised image 64 from a token space to a pixel space. Accordingly, the one or more processing devices 12 may be configured to obtain the generated image 60 from the denoised image 64.

The one or more processing devices 12 are further configured to output the generated image 60. For example, the generated image 60 may be output to the GUI 62 for display to a user.

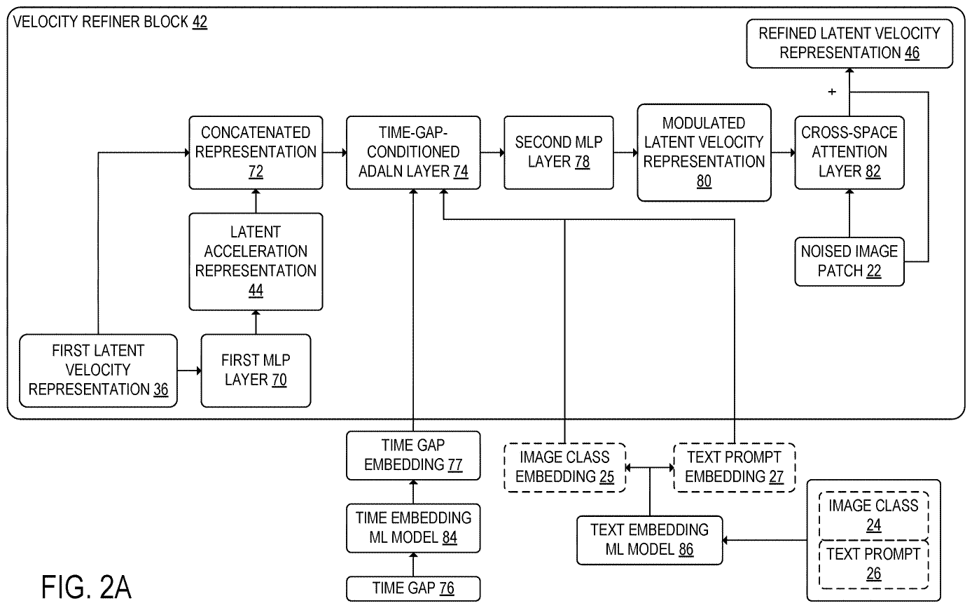

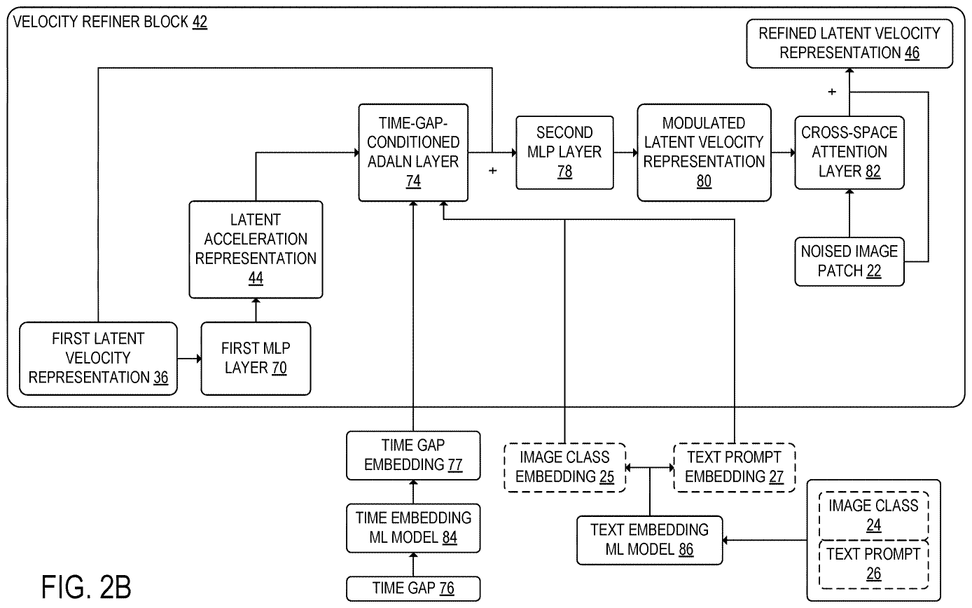

FIG. 2A schematically shows the velocity refiner block 42 in additional detail, according to one example. In the example of FIG. 2A, at the velocity refiner block 42, the one or more processing devices 12 are configured to process the first latent velocity representation 36 at a first multi-layer perceptron (MLP) layer 70 to compute the latent acceleration representation 44. The one or more processing devices 12 are further configured to concatenate the first latent velocity representation 36 with the latent acceleration representation 44 to compute a concatenated representation 72.

The velocity refiner block 42, as depicted in FIG. 2A, further includes a time-gap-conditioned adaptive layer normalization (AdaLN) layer 74 and a second MLP layer 78 that are downstream of the first MLP layer 70. In the example of FIG. 2A, the one or more processing devices 12 are configured to process the concatenated representation 72 at the time-gap-conditioned AdaLN layer 74 and process the output of the time-gap-conditioned AdaLN layer 74 at the second MLP layer 78 to compute a modulated latent velocity representation 80.

The time-gap-conditioned AdaLN layer 74 is conditioned on a time gap 76 between the first timestep t₁ and the second timestep t₂. In order to condition the time-gap-conditioned AdaLN layer 74 on the time gap 76, the one or more processing devices 12 may be configured to compute a time gap embedding 77 at a time embedding ML model 84 using the time gap 76 as input. The time gap embedding 77 may then be used as a conditioning input to the time-gap-conditioned AdaLN layer 74. The one or more processing devices 12 may reuse this time gap embedding 77 at each denoising iteration 56.

As shown in the example of FIG. 2A, the time-gap-conditioned AdaLN layer 74 may be further conditioned on the image class 24 or the text prompt 26. In such examples, the one or more processing devices 12 may be further configured to process the image class 24 or the text prompt 26 at a text embedding ML model 86 to compute an image class embedding 25 or a text prompt embedding 27. The one or more processing devices 12 may be further configured to input the image class embedding 25 or the text prompt embedding 27 into the time-gap-conditioned AdaLN layer 74 as an additional conditioning input. The one or more processing devices 12 may reuse the image class embedding 25 or the text prompt embedding 27 at each denoising iteration 56.

The velocity refiner block 42 further includes a cross-space attention layer 82 downstream of the second MLP layer 78. At the cross-space attention layer 82, the one or more processing devices 12 are further configured to process the noised image patch 22 and the modulated latent velocity representation 80 to compute the refined latent velocity representation 46. In the example of FIG. 2A, the one or more processing devices 12 are configured to input the modulated latent velocity representation 80 and the noised image patch 22 into the cross-space attention layer 82, and are further configured to add a copy of the noised image patch 22 to the output of the cross-space attention layer 82 to obtain the refined latent velocity representation 46. Thus, the one or more processing devices 12 may be further configured to incorporate a representation of the spatial layout of the noised image patch 22 into the refined latent velocity representation 46.

FIG. 2B schematically shows another example architecture of the velocity refiner block 42. In the example of FIG. 2B, rather than inputting a concatenated representation into the time-gap-conditioned AdaLN layer 74, the one or more processing devices 12 are configured to input the latent acceleration representation 44 into the time-gap-conditioned AdaLN layer 74 without concatenating the latent acceleration representation 44 with another input. As in the example of FIG. 2A, the time-gap-conditioned AdaLN layer 74 is conditioned on the time gap 76 and is further conditioned on the image class 24 or the text prompt 26. The one or more processing devices 12 are further configured to add the first latent velocity representation 36 to the output of the time-gap-conditioned AdaLN layer 74, and to input the resulting sum into the second MLP layer 78.

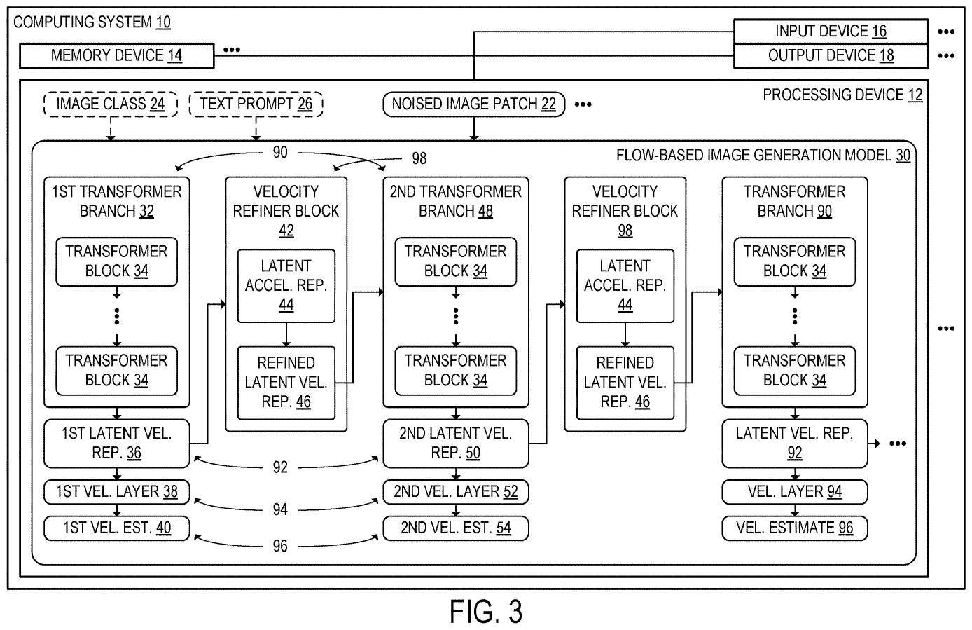

FIG. 3 schematically shows the computing system 10 in an example in which the first transformer branch 32 and the second transformer branch 48 are included among three or more transformer branches 90 in the flow-based image generation model 30. The first latent velocity representation 36 and the second latent velocity representation 50 that are respectively computed at the first transformer branch 32 and the second transformer branch 48 are included among three or more latent velocity representations 92 respectively computed at the transformer branches 90.

In the example of FIG. 3, the first velocity layer 38 and the second velocity layer 52 are included among three or more velocity layers 94 that are downstream of corresponding transformer branches 90 of the three or more transformer branches 90. These velocity layers 94 are associated with corresponding timesteps and are each configured to receive a respective latent velocity representation 92 as input. At each of the velocity layers 94, the one or more processing devices 12 are configured to compute a respective velocity estimate 96. The one or more processing devices 12 are configured to denoise the noised image patch 22 based at least in part on the respective velocity estimates 96 computed at the three or more velocity layers 94.

In the flow-based image generation model 30 depicted in FIG. 3, the velocity refiner block 42 is included among a plurality of velocity refiner blocks 98 that receive respective latent velocity representations 92 from corresponding transformer branches 90 of the three or more transformer branches 90. Each of the velocity refiner blocks 42 outputs a corresponding refined latent velocity representation 46 to a subsequent transformer branch 90 of the three or more transformer branches 90. Thus, each of the transformer branches 90 other than the first transformer branch 32 may receive a velocity representation that has been refined at a corresponding velocity refiner block 98.

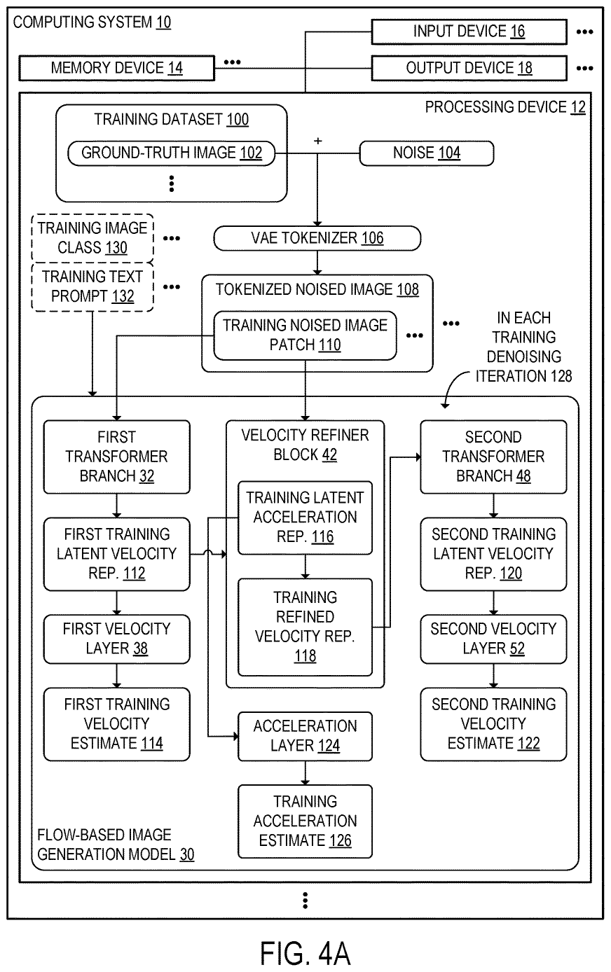

FIGS. 4A-4B schematically show the computing system 10 during training of the flow-based image generation model 30. As shown in FIG. 4A, the flow-based image generation model 30 is trained using a training dataset 100 that includes a plurality of ground-truth images 102. The one or more processing devices 12 are configured to compute a plurality of tokenized noised images 108 from the ground-truth images 102 by adding noise 104 (e.g., Gaussian noise) to each of the ground-truth images 102 and pass the resulting sum through a variational autoencoder (VAE) tokenizer 106. Thus, the one or more processing devices 12 are configured to compute a plurality of tokenized noised images 108 that each include a plurality of training noised image patches 110. These training noised image patches 110 are used as training inputs to the flow-based image generation model 30. As additional training inputs, the flow-based image generation model 30 may be further configured to receive a plurality of training image classes 130 or training text prompts 132 associated with the ground-truth images 102. These training image classes 130 or training text prompts 132 may be image captions.

For each of the training noised image patches 110, in each of a plurality of training denoising iterations 128, the one or more processing devices 12 are further configured to process that training noised image patch 110 at the first transformer branch 32 to compute a first training latent velocity representation 112. In addition, the one or more processing devices 12 are further configured to process the first training latent velocity representation 112 at the first velocity layer 38 to compute a first training velocity estimate 114.

The one or more processing devices 12 are further configured to input the first training latent velocity representation 112 into the velocity refiner block 42, at which the one or more processing devices 12 are further configured to compute a training latent acceleration representation 116 based at least in part on the first training latent velocity representation 112. In addition, the one or more processing devices 12 are further configured to compute a training refined velocity representation 118 at the velocity refiner block 42 based at least in part on the training latent acceleration representation 116.

In the example of FIG. 4A, the one or more processing devices 12 are further configured to process the training latent acceleration representation 116 at an acceleration layer 124 to compute a training acceleration estimate 126. In this example, the acceleration layer 124 is included in the flow-based image generation model 30 during training but omitted during inferencing. The acceleration layer 124 may, for example, be an MLP layer.

The one or more processing devices 12 are further configured to transmit the training refined velocity representation 118 to the second transformer branch 48, at which the one or more processing devices 12 are configured to compute a second training velocity latent representation 120. The one or more processing devices 12 are further configured to process the second training latent representation 120 at a second velocity layer 52 to compute a second training velocity estimate 122.

FIG. 4B schematically shows the computing system 10 when the one or more processing devices 12 are configured to compute a loss function 140 during the training of the flow-based image generation model 30. In this example, the one or more processing devices 12 are configured to train the flow-based image generation model 30 using a loss function 140 that includes a deep supervision loss term 142 and an acceleration loss term 144.

The deep supervision loss term 142 is used to quantify the accuracy of the training velocity estimates computed at the transformer branches, as discussed in further detail below. The one or more processing devices 12 are configured to compute the deep supervision loss term 142 based at least in part on the first training velocity estimate 114 and the second training velocity estimate 122, as well as on a ground-truth velocity embedding 146. The ground-truth velocity embedding 146 may be computed as a difference between a noise embedding 148 and a ground-truth patch embedding 150. The noise embedding and the ground-truth patch embedding 150 may be computed at the VAE tokenizer 106 from respective regions of the noise 104 and the ground-truth image 102 that correspond to the location of the training noised image patch 110.

The one or more processing devices 12 are further configured to compute the acceleration loss term 144 based at least in part on the training acceleration estimate 126 computed at the acceleration layer 124. In the example of FIG. 4B, the computation of the acceleration loss term 144 further utilizes the ground-truth patch embedding 150, the first training velocity estimate 114, and the time gap 76 as inputs.

The acceleration loss term 144 quantifies the accuracy of the training acceleration estimate 126.

Additional details related to the training of the flow-based image generation model 30 are provided below. The deep supervision loss term 142 may be computed according to the following equation:

$${ℒ}_{deep} ( θ ) = 𝔼 [ {\sum }_{i = 1}^{k} {β}^{i} ( {‖ {v}_{θ}^{i} ( {x}_{t}^{i} , t , c ) - V ‖}^{2} ) ] \qquad ( 4 )$$

In the above equation, k is the number of transformer branches 90 included in the flow-based image generation model 30. vⁱ indicates the velocity estimate 96 from the i^{th} velocity layer 94 following the corresponding transformer branch 90, and

$${x}_{t}^{i}$$

denotes input features for the i^{th} branch (defined as xₜ for i=1, and velocity features from the previous transformer branch 90 otherwise). βⁱ are deep supervision coefficients that are used as weighting factors associated with corresponding velocity estimates vⁱ. V is the ground-truth velocity embedding 146. In the following discussion of the loss function 140, the number of transformer branches is set to k=2.

In some examples, the deep supervision loss term 142 may be modified to differentiate between the timesteps for which the velocity layers 94 are configured to generate velocity estimates 96. The deep supervision loss term 142 may be computed according to the following modified equation:

$${ℒ}_{{deep}^{*}} = 𝔼 [ {\sum }_{i = 1}^{2} {β}^{i} ( {‖ {v}_{θ}^{i} ( {x}_{t}^{i} , {t}_{i} , c ) - V ‖}^{2} ) ] \qquad ( 5 )$$

$${v}_{{t}_{1} =} {v}_{θ}^{i} ( {x}_{t}^{1} , {t}_{1} , c ) , {v}_{{t}_{2}} = {v}_{θ}^{2} ( {x}_{t}^{2} , {t}_{2} , c )$$

In the above equation,

$${x}_{t}^{1} and {x}_{t}^{2}$$

indicate the initial noised image patch xₜ, and the first training latent velocity representation

$${v}_{{t}_{1}}^{*}$$

from the previous timestep, respectively. The equation for [symbol] _{deep*} accounts for the use of different timesteps to condition the velocity estimation performed at the transformer branches 90.

The computation of the acceleration loss term 144 is discussed below. The one or more processing devices 12 may be configured to compute the training latent acceleration representation 116 at the acceleration layer 124 according to the following

$${a}_{{t}_{1}}^{*} = ACC\_MLP ( {v}_{{t}_{1}}^{*} ) \qquad ( 6 )$$

The first MLP layer 70 included in the velocity refiner block 42 projects the first training latent velocity representation

$${v}_{{t}_{1}}^{*}$$

from the previous timestep into a higher-dimensional vector space and back into its original vector space, thereby computing the training latent acceleration representation

$${a}_{{t}_{1}}^{*} .$$

As discussed above, the one or more processing devices 12 may be further configured to execute an acceleration layer 124 that receives the training latent acceleration representation

$${a}_{{t}_{1}}^{*}$$

as an input to thereby compute the training acceleration estimate 126, which is indicated below as aₜ_{₁}.

The acceleration loss term 144 may be computed using the following equation:

$${ℒ}_{a c c} = 𝔼 {‖ {2}^{n d} - ODE ( {x}_{{t}_{1}} , {v}_{{t}_{1}} , {a}_{{t}_{1}} , {d}_{{t}_{1} \to 0} ) - {x}_{0} ‖}^{2} \qquad ( 7 )$$

$${2}^{n d} - ODE = {x}_{{t}_{1}} + {v}_{{t}_{1}} ⊙ {d}_{{t}_{1} \to 0} + \frac{1}{2} {a}_{{t}_{1}} ⊙ {( {d}_{{ct}_{1} \to 0} )}^{2}$$

In the above equation, vₜ, and aₜ_{₁} are the first training velocity estimate 114 and the training acceleration estimate 126, respectively. dₜ_{₁}^{→0} is the time gap 76 between the timesteps t₁ and 0. ⊙ indicates the Hadamard product for element-wise matrix multiplication. x₀ is the ground-truth patch embedding 150. By utilizing a kinematic second-order ordinary differential equation (ODE) in the acceleration loss term 144, the one or more processing devices 12 are configured to train the flow-based image generation model 30 to accurately model the acceleration of the normalizing flow.

As discussed above, at the velocity refiner block 42, the one or more processing devices 12 are further configured to concatenate the first training latent velocity representation

$${v}_{{t}_{1}}^{*}$$

with the training latent acceleration representation

$${a}_{{t}_{1}}^{*}$$

and input the resulting concatenated representation 72 into the time-gap-conditioned AdaLN layer 74. At the time-gap-conditioned AdaLN layer 74 and the second MLP layer 78 that follows the time-gap-conditioned AdaLN layer 74, the one or more processing devices 12 may be configured to compute the modulated latent velocity representation 80 according to the following equation:

$$m odulate ( {v}_{{t}_{1}}^{*} ) = MLP ( AdaLN - Zero ( concat ( {v}_{{t}_{1}}^{*} , {a}_{{t}_{1}}^{*} ) , T ( {d}_{{t}_{1} \to {t}_{2}} ) ) ) \qquad ( 8 )$$

In the above equation, dₜ_{₁}_{→t}_{₂} denotes the time gap between t₁ and t₂. T is the time embedding ML model 84, and MLP is the second MLP layer 78. The one or more processing devices 12 are accordingly configured to modulate the concatenated representation 72 based at least in part on the time gap 76.

The one or more processing devices 12 are further configured to integrate spatial data into the velocity refiner block 42 using cross-attention. The cross-space attention layer 82 facilitates interaction between the modulated velocity feature space of the second MLP layer 78 and a spatial feature space of the noised image patches 22. The cross-space attention layer 82 may be implemented according to the following equation:

$${v}_{{t}_{1} \to {t}_{2}}^{*} = CA ( modulate ( {v}_{{t}_{1}}^{*} ) , {x}_{{t}_{1}} ) \qquad ( 9 )$$

In the above equations, the modulated latent velocity representation modulate

$$( {v}_{{t}_{1}}^{*} )$$

is used as the key and value inputs to the cross-space attention layer 82, and the noised image patch xₜ_{₁} is used as the query input. This approach using cross-space attention highlights pertinent spatial features that may have been underrepresented in an exclusively temporal transformation.

The deep supervision loss term 142 and the acceleration loss term 144 may be combined in the loss function 140 according to the following equation:

$${ℒ}_{total} = {ℒ}_{{deep}^{*}} + {λℒ}_{acc} \qquad ( 10 )$$

In the above equation, λ is a hyperparameter that is used to balance the deep supervision loss term 142 and the acceleration loss term 144.

Experiments performed on the flow-based image generation model 30 are discussed below. The following table summarizes the model configurations of the flow-based image generation model 30 that were tested in these experiments:

| Model | Depth | Hidden dimension | Key layer indices |
|---|---|---|---|
| B/2-2T | 12 | 768 | {6, 12} |
| L/2-3T | 18 | 1024 | {6, 12, 18} |
| XL/2-3T | 24 | 1152 | {8, 16, 24} |

In the above table, {k} T denotes that the model includes k key layers, which are the final transformer blocks in respective transformer branches. In these example configurations, the transformer blocks are evenly divided among the transformer branches included in the flow-based image generation model 30.

When training the velocity refiner block, k distinct timesteps were employed while constraining the maximum gap α between consecutive transformer branches. This timestep gap was set to α=0.01. When computing the deep supervision loss term, β was set to 0.2 for intermediate velocity predictions and was set to 1.0 for the final transformer branch. During evaluation, each transformer block was conditioned on a single timestep.

The gaps between these timestep values were set to 0.01. The respective first MLP layer included in each velocity refiner block included four linear layers with sigmoid linear unit (SiLU) activation. This configuration of four linear layers with SiLU activation was also used for the acceleration layer.

During training of the flow-based image generation models 30, the AdamW optimizer was used, with a constant learning rate of 1e−4 and with (β₁, β₂)=(0.9, 0.999). The models were trained without weight decay and with a batch size of 256.

In experiments in which an image class 24 was used as an input to the flow-based image generation model 30, ImageNet-1k was used as a class-conditional image generation benchmark. The flow-based image generation model 30 and a baseline model (referred to herein as Model 1) were each evaluated on ImageNet-1k with and without external self-supervised alignment (SSL align). In examples in which SSL was used, external features received from a pretrained self-supervised model were used to align the refined latent velocity representation 46 with the latent velocity representations 92 computed at the transformer branches. Two different pretrained self-supervised models (DINOᵥ₁ and DINOᵥ₂) were tested for both the flow-based image generation model 30 and the baseline model in this experiment. In addition, two different approaches to timestep sampling during training were evaluated: uniform sampling and lognormal sampling.

The following table shows experimental results for base (B) configurations of the baseline Model 1 and the flow-based image generation model 30:

| Model | Epoch | SSL align | Sampling | FID↓ | sFID↓ | IS↑ |
|---|---|---|---|---|---|---|
| Model | 80 | No | Uniform | 34.4 | 6.5 | 43.7 |
| 1-B | 80 | No | Lognormal | 29.7 | 6.2 | 51.0 |
| | 80 | DINOᵥ₁ | Uniform | 28.3 | 6.6 | 53.8 |
| | 80 | DINOᵥ₁ | Lognormal | 24.4 | 6.3 | 62.1 |
| | 80 | DINOᵥ₂ | Uniform | 23.0 | 6.4 | 59.9 |
| | 80 | DINOᵥ₂ | Lognormal | 20.4 | 6.3 | 72.7 |
| FBIGM- | 80 | No | Uniform | 28.1 | 5.8 | 49.8 |
| B/2-2T | | | | (−6.3) | (−0.7) | (+6.1) |
| | 80 | No | Lognormal | 23.1 | 5.6 | 60.3 |
| | | | | (−6.6) | (−0.6) | (+9.3) |
| | 80 | DINOᵥ₁ | Uniform | 25.6 | 6.4 | 56.6 |
| | | | | (−2.7) | (−0.2) | (+2.8) |
| | 80 | DINOᵥ₁ | Lognormal | 21.7 | 6.1 | 66.0 |
| | | | | (−2.7) | (−0.2) | (+3.9) |
| | 80 | DINOᵥ₂ | Uniform | 20.0 | 6.2 | 70.2 |
| | | | | (−3.0) | (−0.2) | (+10.3) |
| | 80 | DINOᵥ₂ | Lognormal | 17.2 | 60.0 | 77.8 |
| | | | | (−3.2) | (−0.3) | (+5.1) |

The above table demonstrates that without SSL alignment, FBIGM-B/2-2T consistently outperforms Model 1-B under both uniform and lognormal sampling conditions, lowering FID by 6.3 and 6.6, respectively. In examples in which SSL alignment is used, either DINOᵥ₁ or DINOᵥ₂, FBIGM-B/2-2T further reduces the FID by an average of 3.0 points compared to Model 1-B. FBIGM-B/2-2T reached the lowest FID in this experiment (17.2) when DINOᵥ₂ and lognormal sampling were used. More surprisingly, FBIGM-B/2-2T without SSL alignment sometimes achieved higher performance than Model 1-B with SSL alignment via DINOᵥ₁. For example, FBIGM-B/2-2T achieves an FID of 28.1 with uniform sampling compared to the FID of 28.3 reached by Model 1-B. When lognormal sampling was used, FBIGM-B/2-2T without SSL alignment achieved an FID of 23.3, compared to the FID of 24.4 obtained by Model 1-B with DINOᵥ₁ SSL alignment.

The following table shows experimental results for extra-large (XL) configurations of the baseline Model 1 and the flow-based image generation model 30:

| Model | Epoch | SSL align | Sampling | FID↓ | sFID↓ | IS↑ |
|---|---|---|---|---|---|---|
| Model | 80 | No | Lognormal | 13.8 | 5.0 | 91.0 |
| 1-XL | | | | | | |
| | 200 | No | Lognormal | 10.2 | 5.3 | 113.6 |
| | 800 | No | Lognormal | 9.8 | 7.3 | 128.2 |
| | 80 | DINOᵥ₂ | Lognormal | 7.2 | 5.1 | 134.3 |
| | 200 | DINOᵥ₂ | Lognormal | 6.2 | 5.3 | 149.6 |
| | 800 | DINOᵥ₂ | Lognormal | 5.7 | 6.4 | 171.0 |
| FBIGM- | 80 | No | Lognormal | 10.3 | 4.8 | 105.2 |
| XL/2-3T | | | | (−3.4) | (−0.2) | (+14.2) |
| | 200 | No | Lognormal | 7.8 | 4.8 | 127.3 |
| | | | | (−2.4) | (−0.5) | (+13.7) |
| | 400 | No | Lognormal | 7.2 | 5.1 | 138.5 |
| | 80 | DINOᵥ₂ | Lognormal | 6.5 | 4.9 | 134.9 |
| | | | | (−0.7) | (−0.2) | (+0.6) |
| | 200 | DINOᵥ₂ | Lognormal | 5.4 | 5.0 | 151.6 |
| | | | | (−0.8) | (−0.3) | (+2.0) |
| | 400 | DINOᵥ₂ | Lognormal | 5.0 | 5.2 | 162.0 |

The above table demonstrates that FBIGM-XL/2-3T consistently outperforms Model 1-XL at the same training epoch, both with and without SSL alignment. In addition, FBIGM-XL/2-3T converges significantly more quickly than Model 1-XL. For example, FBIGM-XL/2-3T without SSL alignment reaches an FID of 9.8 at just 100 epochs. This FID value matches the performance of Model 1-XL without SSL alignment trained for 800 epochs. Furthermore, at 400 epochs, FBIGM-XL/2-3T surpasses the 800-epoch performance of Model 1-XL on FID and sFID both with and without SSL alignment, and on IS without SSL alignment.

Experiments were also performed to compare the flow-based image generation model 30 to other image generators, including autoregressive, masked generative, diffusion-based, and flow-based models. The following table shows the results of this experiment when the models were evaluated on ImageNet-256×256:

| | Epoch | Parameters | FID↓ | sFID↓ | IS↑ |
|---|---|---|---|---|---|
| Autoregressive | | | | | |
| models | | | | | |
| Model 2 | 50 | 3.1B | 3.05 | — | 222.3 |
| Model 3 | 350 | 1.5B | 2.33 | — | 271.8 |
| Masked generative | | | | | |
| models | | | | | |
| Model 4 | 200 | 287M | 1.97 | — | 281.8 |
| Model 5 | 270 | 307M | 1.78 | — | 319.4 |
| Diffusion-based | | | | | |
| models | | | | | |
| Model 6 | 400 | 554M | 3.94 | 6.14 | 186.7 |
| Model 7 | 800 | — | 2.77 | — | 211.8 |
| Model 8 | 1400 | 675M | 2.27 | 4.60 | 278.2 |
| Flow-based models | | | | | |
| Model 1-XL | 1400 | 675M | 2.06 | 4.50 | 270.3 |
| FBIGM-XL/2-3T | 400 | 681M | 1.97 | 4.39 | 264.7 |
| Model 1-XL + SSL | 800 | 675M | 1.80 | 4.50 | 284.0 |
| align | | | | | |
| FBIGM-XL/2-3T + | 400 | 681M | 1.77 | 4.44 | 271.3 |
| SSL align | | | | | |

The following table shows the results of this experiment when the models were evaluated on ImageNet-512×512:

| | Epoch | Parameters | FID↓ | sFID↓ | IS↑ |
|---|---|---|---|---|---|
| Autoregressive | | | | | |
| models | | | | | |
| Model 9 | 500 | 1.7B | 2.92 | — | — |
| Masked generative | | | | | |
| models | | | | | |
| Model 4 | 200 | 177M | 2.13 | — | — |
| Model 5 | 270 | 307M | 1.91 | — | 324.3 |
| Diffusion-based | | | | | |
| models | | | | | |
| Model 10 | 167 | 400M | 3.60 | — | 247.7 |
| Model 8 | 600 | 676M | 3.04 | — | — |
| Flow-based models | | | | | |
| Model 1-XL | 600 | 676M | 2.62 | 4.18 | 252.2 |
| FBIGM-XL/2-3T | 200 | 682M | 2.59 | 4.23 | 231.1 |
| FBIGM-XL/2-3T | 400 | 682M | 2.22 | 4.27 | 249.4 |
| Model 1-XL + SSL | 200 | 676M | 2.08 | 4.19 | 274.6 |
| align | | | | | |
| FBIGM-XL/2-3T + | 160 | 682M | 2.03 | 4.29 | 248.8 |
| SSL align | | | | | |
| FBIGM-XL/2-3T + | 200 | 682M | 1.96 | 4.28 | 260.3 |
| SSL align | | | | | |

The above tables demonstrate that the flow-based image generation model 30 outperforms other flow-based models and achieves performance competitive with or higher than that of image generators with other types of architectures. In addition, the flow-based image generation model 30 may be trained efficiently. For example, the flow-based image generation model 30 outperforms Model 1-XL on ImageNet256×256 and ImageNet512×512 with half the number of epochs.

An experiment was also performed to evaluate the flow-based image generation model 30 on a text-to-image generation task. In this experiment, a flow-matching objective was incorporated into the objective function during training of both the flow-based image generation model 30 and Model 1. The models were trained on the MS-COCO training set. Both models had a hidden dimension of 768 and 24 transformer layers, and both models used uniform timestep sampling. The models were evaluated on the MS-COCO validation set and the GenEval benchmark.

The following table shows the results of the text-to-image generation experiment:

| | | MS- | | | | |
|---|---|---|---|---|---|---|
| | SSL | COCO | | | | GenEval |
| Model | align | FID↓ | FID_{DINOv2}↓ | IS↑ | CLIP↑ | Overall↑ |
| Model 1 | No | 5.38 | 408.27 | 31.1 | 0.2954 | 0.2672 |
| | DINOᵥ₂ | 4.24 | 274.19 | 34.4 | 0.2979 | 0.3166 |
| FBIGM- | No | 5.32 | 343.60 | 33.0 | 0.2974 | 0.2957 |
| XL/2-3T | | | | | | |
| | DINOᵥ₂ | 4.18 | 216.20 | 35.9 | 0.3010 | 0.3458 |

The above results demonstrate that the flow-based image generation model 30 outperforms the baseline model on each of the tested metrics at the text-to-image generation task.

A first ablation study was also performed on the effects that different components of the flow-based image generation model 30 had on FID. This ablation study compared the flow-based image generation model 30 to Model 1-B. The results of the first ablation study are shown in the following table:

| Model | FID↓ |
|---|---|
| Model 1-B | 34.4 |
| +Deep supervision | 33.0 |
| +Time gap | 31.1 |
| +Inter-layer acceleration | 29.9 |
| +Cross-space attention | 28.1 |

As shown in the above table, deep supervision on each transformer branch reduces FID to 33.0 by aligning intermediate velocity features with the ground-truth velocity. Adding a time gap mechanism further lowers FID to 31.1 by increasing robustness to timestep variations. An inter-layer acceleration pipeline within the velocity refiner block decreases FID to 29.9, and incorporating a cross-space attention layer refines spatial fusion to achieve a final FID of 28.1. Overall, these components yield a total FID reduction of 6.3.

In a second ablation study, different values of the maximum time gap α between different transformer branches were tested during training of the flow-based image generation model 30. The following table shows the results of this second ablation study:

| Model | α | FID↓ |
|---|---|---|
| FBIGM-B/2-2T | 0.1 | 28.9 |
| | 0.05 | 28.6 |
| | 0.01 | 28.1 |
| | 0.005 | 28.3 |
| | 0.001 | 28.5 |

As shown in the above table, the lowest FID was achieved when a was set to 0.01. The performance of the flow-based image generation model 30 was relatively stable across different values of α.

In a third ablation study, different values of A were used when computing the value of the loss function 140 during the training of the flow-based image generation model 30. This ablation study further included changing the number of layers and channels included in the first MLP layer 70. In addition, different values of 1 were tested for both uniform and lognormal sampling. The following table shows the results of this ablation study:

| Model | λ | Acceleration MLP | FID↓ |
|---|---|---|---|
| FBIGM-B/2-2T | 1.0 | {2048, 768} | 30.4 |
| (uniform) | 0.5 | {2048, 4096, 2048, 768} | 27.8 |
| | 0.75 | (2048, 4096, 2048, 768} | 28.1 |
| | 1.0 | {2048, 4096, 2048, 768} | 28.1 |
| | 1.25 | {2048, 4096, 2048, 768} | 28.5 |
| | 1.5 | {2048, 4096, 2048, 768} | 28.8 |
| FBIGM-B/2-2T | 0.5 | {2048, 4096, 2048, 768} | 23.5 |
| (lognormal) | 1.0 | {2048, 4096, 2048, 768} | 23.1 |

In the above table, the numbers in brackets indicate the channel sizes of respective layers included in the first MLP layer 70. The above table shows that for both uniform and lognormal sampling, the lowest FID was reached at λ=1.0. In addition, including additional deep layers in the first MLP layer 70 decreased the FID.

The following table compares base (B), large (L), and extra large (XL) configurations of the flow-based image generation model 30 to the baseline Model 1 in terms of transformer depth, parameter count, GFLOPS, and FID. Each of these models was trained for 80 epochs with lognormal sampling. The models were evaluated on ImageNet256×256 without classifier-free guidance.

| Model | Depth | Parameters | GFLOPS | FID↓ |
|---|---|---|---|---|
| Model 1-B | 12 | 130M | 24 | 29.7 |
| Model 1-L | 24 | 458M | 80 | 16.1 |
| Model 1-XL | 28 | 675M | 114 | 13.7 |
| FBIGM-B/2-2T | 10 | 144M | 24 | 27.3 |
| | 12 | 166M | 28 | 23.1 |
| FBIGM-L/2-2T | 20 | 431M | 72 | 13.9 |
| | 22 | 469M | 78 | 13.3 |
| | 24 | 507M | 84 | 12.8 |
| FBIGM-XL/2-2T | 22 | 588M | 97 | 11.9 |
| | 24 | 636M | 106 | 11.7 |
| | 26 | 683M | 114 | 11.1 |
| | 28 | 731M | 122 | 11.1 |
| FBIGM-L/2-3T | 18 | 433M | 72 | 13.3 |
| | 21 | 490M | 82 | 12.0 |
| | 24 | 547M | 92 | 11.9 |
| FBIGM-XL/2-3T | 18 | 538M | 89 | 12.4 |
| | 21 | 609M | 101 | 10.9 |
| | 24 | 681M | 113 | 10.3 |
| | 27 | 753M | 125 | 10.0 |
| FBIGM-XL/2-4T | 28 | 822M | 137 | 9.7 |

The above table shows efficient performance scaling in which smaller versions of the flow-based image generation model 30 have similar performance to larger versions of Model 1. For example, FBIGM-L/2-3T (18 layers, 433M parameters, 72 GFLOPS) achieves an FID of 13.3, which is slightly below that of Model 1-XL (28 layers, 675M parameters, 114 GFLOPS, 13.7 FID). The flow-based image generation model 30 also consistently achieves higher performance (in terms of lower FID) than versions of Model 1 that are similar in size. For example, FBIGM-XL/2-3T has an FID 3.4 points lower than that of Model 1-XL while having a slightly lower training cost (in terms of GFLOPS). The flow-based image generation model 30 also scales effectively, with FBIGM-XL/2-4T further lowering the FID to 9.7.

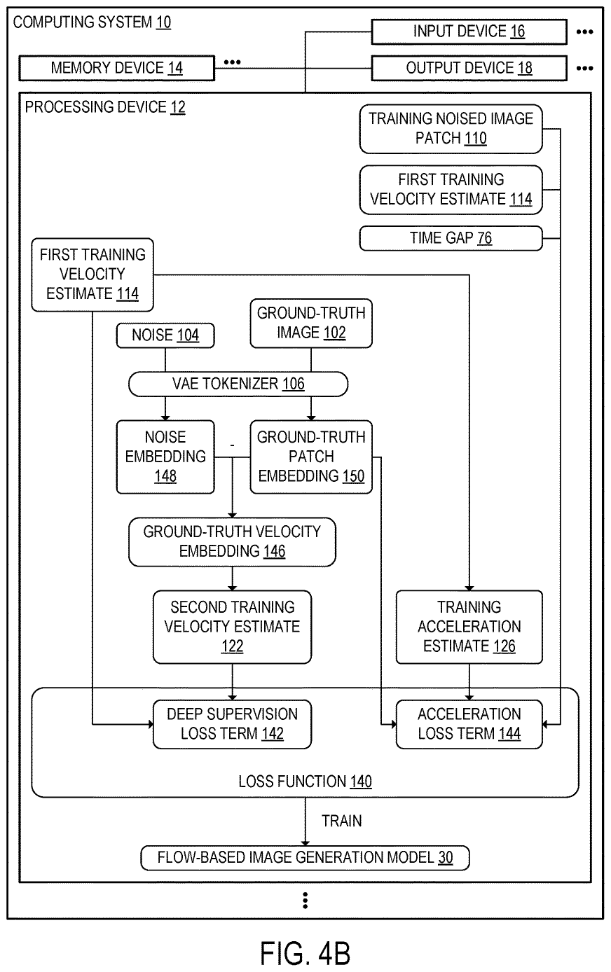

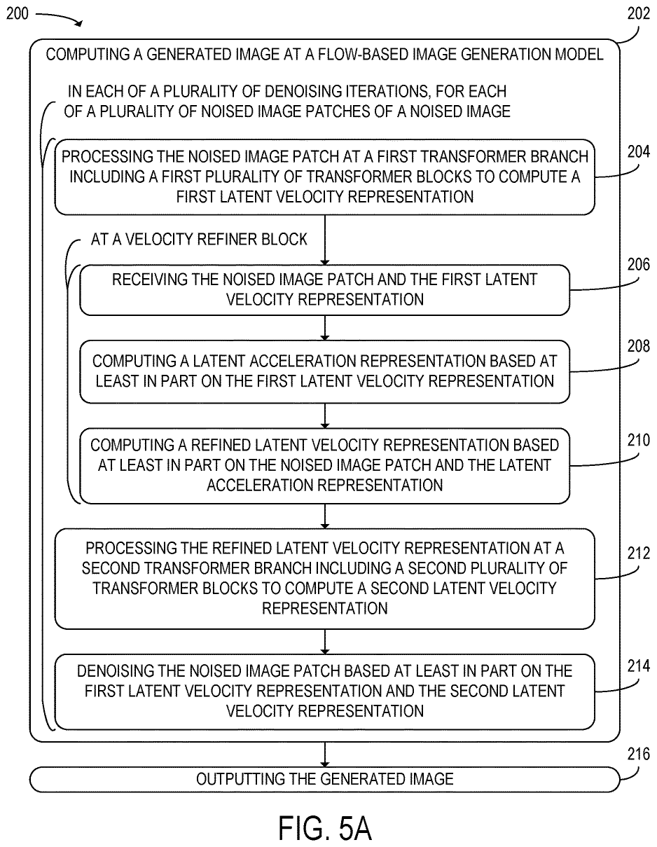

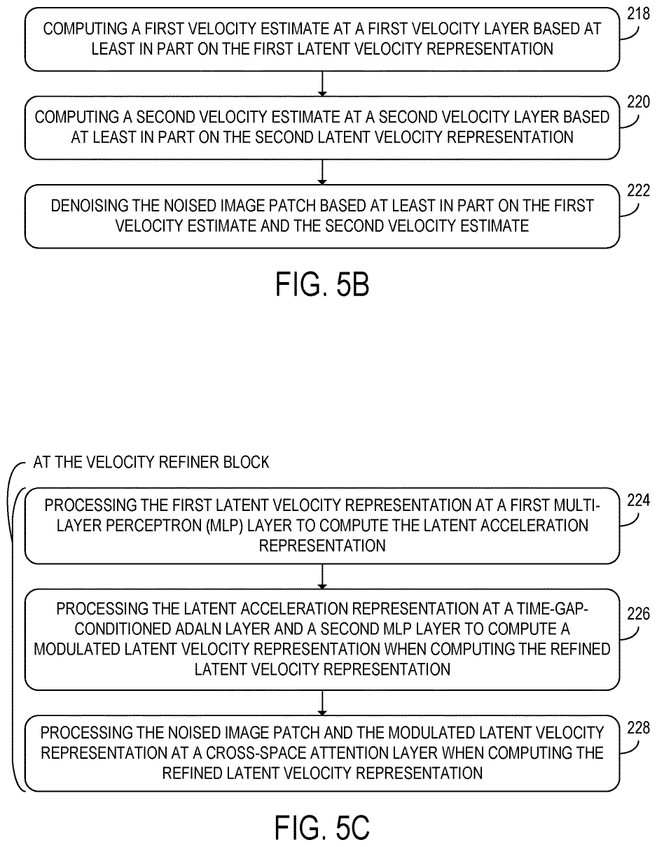

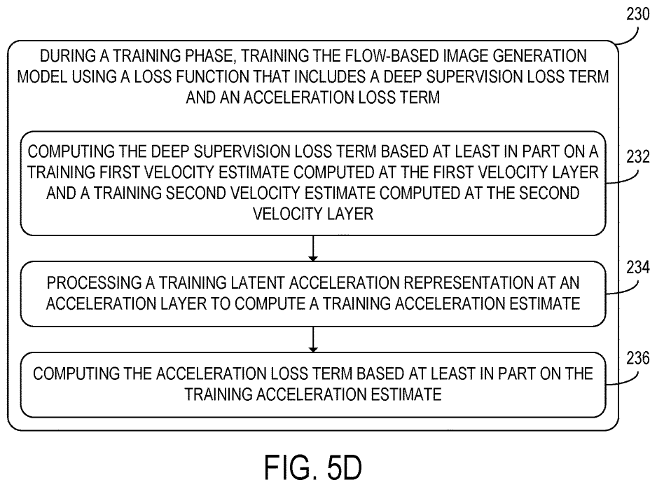

FIG. 5A shows a flowchart of an example method 200 for use with a computing system to compute an image at a flow-based image generation model, according to one example. At step 202, the method 200 includes computing a generated image at a flow-based image generation model. Step 202 includes steps 204, 206, 208, 210, 212, and 214, each of which is performed in each of a plurality of denoising iterations and for each of a plurality of noised image patches of a noised image. In some examples, the generated image is computed via class-conditional generation, in which an image class is used as an additional input to the flow-based image generation model. Alternatively, the generated image may be computed via text-to-image generation, in which a text prompt is used as an additional input to the flow-based image generation model.

At step 204, step 202 of the method 200 includes processing the noised image patch at a first transformer branch including a first plurality of transformer blocks to compute a first latent velocity representation. The latent velocity representation is associated with a first timestep.

Steps 206, 208, and 210 are each performed at a velocity refiner block included in the flow-based image generation model. At step 206, step 202 further includes receiving the noised image patch and the first latent velocity representation. At step 208, step 202 further includes computing a latent acceleration representation based at least in part on the first latent velocity representation. At step 210, step 202 further includes computing a refined latent velocity representation based at least in part on the noised image patch and the latent acceleration representation. The noised image patch may accordingly be used to incorporate spatial data included in the noised image patch into the refined latent velocity representation.

At step 212, step 202 further includes processing the refined latent velocity representation at a second transformer branch including a second plurality of transformer blocks to compute a second latent velocity representation. The refined latent velocity representation may accordingly be used to align the first latent velocity representation with the second latent velocity representation.

At step 214, step 202 further includes denoising the noised image patch based at least in part on the first latent velocity representation and the second latent velocity representation. In a final denoising iteration, computing the generated image may further include executing a pretrained decoder to convert the denoised image patches from token space to pixel space.

At step 216, the method 200 further includes outputting the generated image. For example, the generated image may be output to a user interface for display to a user. Additionally or alternatively, the generated image may be output to an ML model training process for use as synthetic training data.

FIGS. 5B-5D show additional steps of the method 200 that may be performed in some examples. FIG. 5B shows steps that may be performed in examples in which the flow-based image generation model further includes a first velocity layer and a second velocity layer. At step 218, the method 200 may further include computing a first velocity estimate at a first velocity layer based at least in part on the first latent velocity representation. In addition, at step 220, the method 200 may further include computing a second velocity estimate at a second velocity layer based at least in part on the second latent velocity representation. The flow-based image generation model may include three or more velocity layers in some examples.

At step 222, the method 200 may further include denoising the noised image patch based at least in part on the first velocity estimate and the second velocity estimate. Denoising the noised image patch may include computing a time-dependent velocity field over the noised image patch based at least in part on the first velocity estimate and the second velocity estimate. In examples in which the flow-based image generation model includes three or more velocity layers, respective velocity estimates computed at those velocity layers may be used to compute the velocity field. The time-dependent velocity field may be further utilized to compute a denoised image patch in tokenized form.

The steps shown in FIG. 5C are performed at the velocity refiner block. These steps are performed in each of the denoising iterations for each of the noised image patches. At step 224, the method 200 may further include processing the first latent velocity representation at a first multi-layer perceptron (MLP) layer to compute the latent acceleration representation.

In the example of FIG. 5B, the velocity refiner block may further include a time-gap-conditioned AdaLN layer and a second MLP layer. The time-gap-conditioned AdaLN layer and the second MLP layer may be downstream of the first MLP layer. At step 226, when computing the refined latent velocity representation, the method 200 may further include processing the latent acceleration representation at the time-gap-conditioned AdaLN layer and the second MLP layer to compute a modulated latent velocity representation.

The velocity refiner block may further include a cross-space attention layer, which may be located downstream of the second MLP layer. At step 228, the method 200 may further include processing the noised image patch and the modulated latent velocity representation at the cross-space attention layer when computing the refined latent velocity representation. A copy of the noised image patch may also be added to the output of the cross-space attention layer. Accordingly, spatial data included in the noised image patch may be combined with the modulated latent velocity representation to obtain the refined latent velocity representation.

FIG. 5D shows additional steps of the method 200 that may be performed during a training phase for the flow-based image generation model. At step 230, the method 200 may further include training the flow-based image generation model using a loss function that includes a deep supervision loss term and an acceleration loss term. At step 232, step 230 may include computing the deep supervision loss term based at least in part on a training first velocity estimate computed at the first velocity layer and a training second velocity estimate computed at the second velocity layer. For example, the deep supervision loss term may be computed as a weighted sum of mean-squared error values between the velocity estimates and a ground-truth velocity embedding. In such examples, the ground-truth velocity embedding may be a difference between respective embeddings of noise and a ground-truth image.

At step 234, step 230 may further include processing a training latent acceleration representation at an acceleration layer to compute a training acceleration estimate. At step 236, step 230 may further include computing the acceleration loss term based at least in part on the training acceleration estimate. The acceleration loss term may, for example, be computed at least in part by computing a plurality of kinematic estimates of a ground-truth patch embedding. The kinematic estimates may be computed based at least in part on a training noised image patch, a first training velocity estimate, the time gap between the transformer branches, and the training acceleration estimate. The acceleration loss term may then be computed as a mean squared error of the kinematic estimates relative to corresponding ground-truth patch embeddings.

According to the systems and methods presented above, a flow-based image generation model including a velocity refiner block is provided. The velocity refiner block is located between transformer branches and is used to align the velocity representations computed at those transformer branches. At the velocity refiner block, the flow-based image generation model estimates acceleration data and uses this acceleration data to compute a refined latent velocity representation. The refined latent velocity representation further incorporates spatial information from a noised image patch. As the experimental results for the flow-based image generation model demonstrate, including the velocity refiner block increases generated image quality compared to baselines. The velocity refiner block also allows the training of the flow-based image generation model to converge more quickly, thereby increasing the computational efficiency of training.

The methods and processes described herein are tied to a computing system of one or more computing devices. In particular, such methods and processes can be implemented as a computer-application program or service, an application-programming interface (API), a library, and/or other computer-program product.

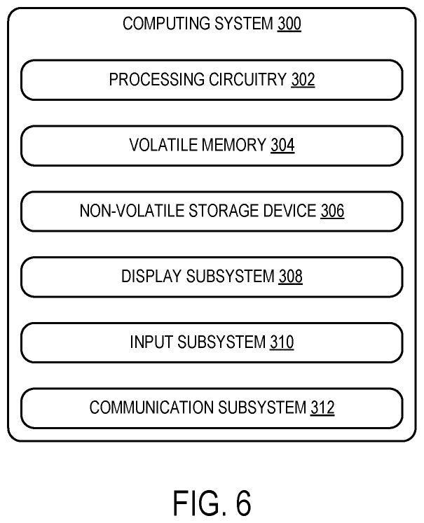

FIG. 6 schematically shows a non-limiting embodiment of a computing system 300 that can enact one or more of the methods and processes described above. Computing system 300 is shown in simplified form and may instantiate the computing system 10 depicted in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed, e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory 304, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to compute a generated image at a flow-based image generation model at least in part by, in each of a plurality of denoising iterations, for each of a plurality of noised image patches of a noised image, processing the noised image patch at a first transformer branch including a first plurality of transformer blocks to compute a first latent velocity representation. At a velocity refiner block, computing the generated image further includes receiving the noised image patch and the first latent velocity representation, computing a latent acceleration representation based at least in part on the latent acceleration representation, and computing a refined latent velocity representation based at least in part on the noised image patch and the first latent velocity representation. Computing the generated image further includes, for each of the noised image patches, processing the refined latent velocity representation at a second transformer branch including a second plurality of transformer blocks to compute a second latent velocity representation. Computing the generated image further includes, for each of the noised image patches, denoising the noised image patch based at least in part on the first latent velocity representation and the second latent velocity representation. The one or more processing devices are further configured to output the generated image. The above features may have the technical effect of aligning the latent velocity representations computed at the transformer branches, thereby resulting in higher generated image quality.

According to this aspect, the one or more processing devices may be further configured to compute a first velocity estimate at a first velocity layer based at least in part on the first latent velocity representation. The one or more processing devices may be further configured to compute a second velocity estimate at a second velocity layer based at least in part on the second latent velocity representation. The one or more processing devices may be further configured to denoise the noised image patch based at least in part on the first velocity estimate and the second velocity estimate. The above features may have the technical effect of using velocity estimates to compute the contents of the denoised image patch.

According to this aspect, the first transformer branch and the second transformer branch may be included among three or more transformer branches in the flow-based image generation model. The first velocity layer and the second velocity layer may be included among three or more velocity layers that are downstream of corresponding transformer branches of the three or more transformer branches. The one or more processing devices may be configured to denoise the noised image patch based at least in part on respective velocity estimates computed at the three or more velocity layers. The above features may have the technical effect of utilizing velocity estimates across three or more timesteps to increase the quality of the denoised image patch.

According to this aspect, the velocity refiner block may be included among a plurality of velocity refiner blocks that receive respective velocity estimates from corresponding transformer branches of the three or more transformer branches. Each of the velocity refiner blocks may output a corresponding refined latent velocity representation to a subsequent transformer branch of the three or more transformer branches. The above features may have the technical effect of aligning the velocity representations computed at the three or more transformer branches.

According to this aspect, at the velocity refiner block, the one or more processing devices may be configured to process the first latent velocity representation at a first multi-layer perceptron (MLP) layer to compute the latent acceleration representation. The above features may have the technical effect of computing the latent acceleration representation from the first latent velocity representation.

According to this aspect, the velocity refiner block may further include a time-gap-conditioned adaptive layer normalization (AdaLN) layer and a second MLP layer. The one or more processing devices may be further configured to process the latent acceleration representation at the time-gap-conditioned AdaLN layer and the second MLP layer to compute a modulated latent velocity representation when computing the refined latent velocity representation. The above features may have the technical effect of aligning the second latent velocity representation with the first latent velocity representation based at least in part on a time gap.

According to this aspect, the velocity refiner block may further include a cross-space attention layer. The one or more processing devices may be further configured to process the noised image patch and the modulated latent velocity representation at the cross-space attention layer when computing the refined latent velocity representation. The above features may have the technical effect of representing a spatial layout of image features in the refined latent velocity representation.

According to this aspect, the first velocity estimate may be associated with a first timestep. The second velocity estimate may be associated with a second timestep. The time-gap-conditioned AdaLN layer is conditioned on a time gap between the first timestep and the second timestep. The above features may have the technical effect of aligning the second latent velocity representation with the first latent velocity representation based at least in part on the time gap between the velocity estimates.

According to this aspect, during a training phase, the one or more processing devices may be further configured to train the flow-based image generation model using a loss function that includes a deep supervision loss term and an acceleration loss term. The above features may have the technical effect of increasing the alignment of the internal velocity representations with output velocity representations.

According to this aspect, the one or more processing devices may be configured to compute the deep supervision loss term based at least in part on a training first velocity estimate computed at the first velocity layer and a training second velocity estimate computed at the second velocity layer. The above features may have the technical effect of training the flow-based image generation model based at least in part on the accuracy of the training velocity estimates.

According to this aspect, the one or more processing devices may be further configured to process a training latent acceleration representation at an acceleration layer to compute a training acceleration estimate. The one or more processing devices may be further configured to compute the acceleration loss term based at least in part on the training acceleration estimate. The above features may have the technical effect of training the flow-based image generation model based at least in part on the accuracy of the training acceleration estimates.

According to another aspect of the present disclosure, a method for use with a computing system is provided. The method includes computing a generated image at a flow-based image generation model at least in part by, in each of a plurality of denoising iterations, for each of a plurality of noised image patches of a noised image, processing the noised image patch at a first transformer branch including a first plurality of transformer blocks to compute a first latent velocity representation. At a velocity refiner block, the method further includes receiving the noised image patch and the first latent velocity representation, computing a latent acceleration representation based at least in part on the first latent velocity representation, and computing a refined latent velocity representation based at least in part on the noised image patch and the latent acceleration representation. The method further includes processing the refined latent velocity representation at a second transformer branch including a second plurality of transformer blocks to compute a second latent velocity representation. The method further includes denoising the noised image patch based at least in part on the first latent velocity representation and the second latent velocity representation. The method further includes outputting the generated image. The above features may have the technical effect of aligning the latent velocity representations computed at the transformer branches, thereby resulting in higher generated image quality.

According to this aspect, the method may further include computing a first velocity estimate at a first velocity layer based at least in part on the first latent velocity representation. The method may further include computing a second velocity estimate at a second velocity layer based at least in part on the second latent velocity representation. The method may further include denoising the noised image patch based at least in part on the first velocity estimate and the second velocity estimate. The above features may have the technical effect of using velocity estimates to compute the contents of the denoised image patch.

According to this aspect, the method may further include, at the velocity refiner block, processing the first latent velocity representation at a first multi-layer perceptron (MLP) layer to compute the latent acceleration representation. The above features may have the technical effect of computing the latent acceleration representation from the first latent velocity representation.

According to this aspect, the velocity refiner block may further include a time-gap-conditioned adaptive layer normalization (AdaLN) layer and a second MLP layer. The method may further include processing the latent acceleration representation at the time-gap-conditioned AdaLN layer and the second MLP layer to compute a modulated latent velocity representation when computing the refined latent velocity representation. The above features may have the technical effect of aligning the second latent velocity representation with the first latent velocity representation based at least in part on a time gap.

According to this aspect, the velocity refiner block may further include a cross-space attention layer. The method may further include processing the noised image patch and the modulated latent velocity representation at the cross-space attention layer when computing the refined latent velocity representation. The above features may have the technical effect of representing a spatial layout of image features in the refined latent velocity representation.

According to this aspect, the first velocity estimate may be associated with a first timestep. The second velocity estimate may be associated with a second timestep. The time-gap-conditioned AdaLN layer may be conditioned on a time gap between the first timestep and the second timestep. The above features may have the technical effect of aligning the second latent velocity representation with the first latent velocity representation based at least in part on the time gap between the velocity estimates.

According to this aspect, during a training phase, the method may further include training the flow-based image generation model using a loss function that includes a deep supervision loss term and an acceleration loss term. The above features may have the technical effect of increasing the alignment of the internal velocity representations with output velocity representations.

According to this aspect, the method may further include computing the deep supervision loss term based at least in part on a training first velocity estimate computed at the first velocity layer and a training second velocity estimate computed at the second velocity layer. The method may further include processing a training latent acceleration representation at an acceleration layer to compute a training acceleration estimate. The method may further include computing the acceleration loss term based at least in part on the training acceleration estimate. The above features may have the technical effect of training the flow-based image generation model based at least in part on the accuracy of the training velocity estimates and the training acceleration estimates.

According to another aspect of the present disclosure, a computing system is provided, including one or more processing devices configured to compute a generated image at a flow-based image generation model at least in part by, in each of a plurality of denoising iterations, for each of a plurality of noised image patches of a noised image, computing a respective latent velocity representation at each of a plurality of transformer branches. Each of the transformer branches includes a plurality of transformer blocks. Computing the generated image further includes, at a plurality of velocity layers, computing a respective plurality of velocity estimates based at least in part on corresponding latent velocity representations received from the transformer branches. Computing the generated image further includes denoising the noised image patch based at least in part on the plurality of velocity estimates. The flow-based image generation model is trained using a loss function that includes a deep supervision loss term. The deep supervision loss term is computed based at least in part on a plurality of training velocity estimates computed at the velocity layers. The one or more processing devices are further configured to output the generated image. The above features may have the technical effect of computing the generated image at a flow-based image generation model that has been trained in a manner that increases the alignment of the internal velocity representations with output velocity representations.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
compute a generated image at a flow-based image generation model at least in part by, in each of a plurality of denoising iterations, for each of a plurality of noised image patches of a noised image:
processing the noised image patch at a first transformer branch including a first plurality of transformer blocks to compute a first latent velocity representation;
at a velocity refiner block:
receiving the noised image patch and the first latent velocity representation;
computing a latent acceleration representation based at least in part on the latent acceleration representation; and
computing a refined latent velocity representation based at least in part on the noised image patch and the first latent velocity representation;
processing the refined latent velocity representation at a second transformer branch including a second plurality of transformer blocks to compute a second latent velocity representation; and
denoising the noised image patch based at least in part on the first latent velocity representation and the second latent velocity representation; and
output the generated image.

2. The computing system of claim 1, wherein the one or more processing devices are further configured to:
compute a first velocity estimate at a first velocity layer based at least in part on the first latent velocity representation;
compute a second velocity estimate at a second velocity layer based at least in part on the second latent velocity representation; and
denoise the noised image patch based at least in part on the first velocity estimate and the second velocity estimate.

3. The computing system of claim 2, wherein:
the first transformer branch and the second transformer branch are included among three or more transformer branches in the flow-based image generation model;
the first velocity layer and the second velocity layer are included among three or more velocity layers that are downstream of corresponding transformer branches of the three or more transformer branches; and
the one or more processing devices are configured to denoise the noised image patch based at least in part on respective velocity estimates computed at the three or more velocity layers.

4. The computing system of claim 3, wherein:
the velocity refiner block is included among a plurality of velocity refiner blocks that receive respective velocity estimates from corresponding transformer branches of the three or more transformer branches; and
each of the velocity refiner blocks outputs a corresponding refined latent velocity representation to a subsequent transformer branch of the three or more transformer branches.

5. The computing system of claim 2, wherein, at the velocity refiner block, the one or more processing devices are configured to process the first latent velocity representation at a first multi-layer perceptron (MLP) layer to compute the latent acceleration representation.

6. The computing system of claim 4, wherein:
the velocity refiner block further includes a time-gap-conditioned adaptive layer normalization (AdaLN) layer and a second MLP layer; and
the one or more processing devices are further configured to process the latent acceleration representation at the time-gap-conditioned AdaLN layer and the second MLP layer to compute a modulated latent velocity representation when computing the refined latent velocity representation.

7. The computing system of claim 6, wherein:
the velocity refiner block further includes a cross-space attention layer; and
the one or more processing devices are further configured to process the noised image patch and the modulated latent velocity representation at the cross-space attention layer when computing the refined latent velocity representation.

8. The computing system of claim 6, wherein:
the first velocity estimate is associated with a first timestep;
the second velocity estimate is associated with a second timestep; and
the time-gap-conditioned AdaLN layer is conditioned on a time gap between the first timestep and the second timestep.

9. The computing system of claim 2, wherein, during a training phase, the one or more processing devices are further configured to train the flow-based image generation model using a loss function that includes a deep supervision loss term and an acceleration loss term.

10. The computing system of claim 9, wherein the one or more processing devices are configured to compute the deep supervision loss term based at least in part on a training first velocity estimate computed at the first velocity layer and a training second velocity estimate computed at the second velocity layer.

11. The computing system of claim 9, wherein the one or more processing devices are further configured to:
process a training latent acceleration representation at an acceleration layer to compute a training acceleration estimate; and
compute the acceleration loss term based at least in part on the training acceleration estimate.

12. A method for use with a computing system, the method comprising:
computing a generated image at a flow-based image generation model at least in part by, in each of a plurality of denoising iterations, for each of a plurality of noised image patches of a noised image:
processing the noised image patch at a first transformer branch including a first plurality of transformer blocks to compute a first latent velocity representation;
at a velocity refiner block:
receiving the noised image patch and the first latent velocity representation;
computing a latent acceleration representation based at least in part on the first latent velocity representation; and
computing a refined latent velocity representation based at least in part on the noised image patch and the latent acceleration representation;
processing the refined latent velocity representation at a second transformer branch including a second plurality of transformer blocks to compute a second latent velocity representation; and
denoising the noised image patch based at least in part on the first latent velocity representation and the second latent velocity representation; and
outputting the generated image.

13. The method of claim 12, further comprising:
computing a first velocity estimate at a first velocity layer based at least in part on the first latent velocity representation;
computing a second velocity estimate at a second velocity layer based at least in part on the second latent velocity representation; and
denoising the noised image patch based at least in part on the first velocity estimate and the second velocity estimate.

14. The method of claim 13, further comprising, at the velocity refiner block, processing the first latent velocity representation at a first multi-layer perceptron (MLP) layer to compute the latent acceleration representation.

15. The method of claim 14, wherein:
the velocity refiner block further includes a time-gap-conditioned adaptive layer normalization (AdaLN) layer and a second MLP layer; and
the method further comprises processing the latent acceleration representation at the time-gap-conditioned AdaLN layer and the second MLP layer to compute a modulated latent velocity representation when computing the refined latent velocity representation.

16. The method of claim 15, wherein:
the velocity refiner block further includes a cross-space attention layer; and
the method further comprises processing the noised image patch and the modulated latent velocity representation at the cross-space attention layer when computing the refined latent velocity representation.

17. The method of claim 15, wherein:
the first velocity estimate is associated with a first timestep;
the second velocity estimate is associated with a second timestep; and
the time-gap-conditioned AdaLN layer is conditioned on a time gap between the first timestep and the second timestep.

18. The method of claim 13, further comprising, during a training phase, training the flow-based image generation model using a loss function that includes a deep supervision loss term and an acceleration loss term.

19. The method of claim 18, further comprising:
computing the deep supervision loss term based at least in part on a training first velocity estimate computed at the first velocity layer and a training second velocity estimate computed at the second velocity layer;
processing a training latent acceleration representation at an acceleration layer to compute a training acceleration estimate; and
computing the acceleration loss term based at least in part on the training acceleration estimate.

20. A computing system comprising:
one or more processing devices configured to:
compute a generated image at a flow-based image generation model at least in part by, in each of a plurality of denoising iterations, for each of a plurality of noised image patches of a noised image:
computing a respective latent velocity representation at each of a plurality of transformer branches, wherein each of the transformer branches includes a plurality of transformer blocks;
at a plurality of velocity layers, computing a respective plurality of velocity estimates based at least in part on corresponding latent velocity representations received from the transformer branches; and
denoising the noised image patch based at least in part on the plurality of velocity estimates, wherein:
the flow-based image generation model is trained using a loss function that includes a deep supervision loss term; and
the deep supervision loss term is computed based at least in part on a plurality of training velocity estimates computed at the velocity layers; and
output the generated image.
